(19) United States
(12) Patent Application Publication
(10) Pub. No.: US 2021/0310852 A1
(43) Pub. Date: Oct. 7, 2021

(54) SMART LUGGAGE ASSEMBLY

(71) Applicant: Alberto Carballeira, Miami, FL (US)

(72) Inventor: Alberto Carballeira, Miami, FL (US)

(21) Appl. No.: 17/194,475

(22) Filed: Mar. 8, 2021

Related U.S. Application Data
(60) Provisional application No. 63/006,179, filed on Apr. 7, 2020.

(51) Int. Cl. G01G 19/12; A45C 5/03; A45C 5/14; A45C 15/00

(52) U.S. Cl. CPC G01G 19/12; A45C 15/00; A45C 5/14; A45C 5/03

(57) ABSTRACT

A smart luggage assembly and a method for ensuring the weight and number of smart luggage assemblies comports to air carrier requirements and guidelines. The smart luggage assembly comprises a case with at least one independent segment and a detection assembly disposed on a bottom portion thereof. The detection assembly comprises a weight sensor configured to ascertain the weight of a corresponding the independent segment. The smart luggage assembly further comprises a service assembly configured to display its weight. One or more smart luggage assemblies may be cooperatively configured with a user platform to conveniently access information related to their respective weights.

### FIELD OF INVENTION

The present invention relates to the field of luggage units comprising electronic features.

### BACKGROUND

Existing pieces of luggage generally do not generally provide for a convenient way to ascertain and display their own weight. Standalone mechanical and electronic scales have various drawbacks, including their lack of accuracy, and the fact that they are generally not an integral component of the luggage units themselves. Further drawback associated with weight scales and existing pieces of luggage involve the fact that even if both are provided, it is often difficult to visually determine an accurate weight reading, especially in connection with mechanical scales.

Accordingly, there is a need in the industry for a smart luggage assembly capable of automatically ascertaining its own weight. A benefit in the industry would be realized by providing a smart luggage assembly with a built in detection assembly that could ascertain the weight of the luggage and conveniently display it on the luggage itself. A further benefit would be provided by providing a smart luggage assembly with a solar panel capable of transforming solar energy into electricity for the functioning of various operative components of the smart luggage assembly. An even further benefit would be provided by providing a smart luggage assembly that may be cooperatively configured with a user platform to effectively manage the weight of the smart luggage assembly and compare it to air carrier requirements and guidelines.

### SUMMARY

The present invention is directed towards a smart luggage assembly and to a method of using a user platform to check its weight and ensure conformance to airline carrier requirements and guidelines. The smart luggage assembly comprises a case with one or more independent segments. The smart luggage assembly also comprises a detection assembly configured to ascertain the weight associated with an independent segment(s). The smart luggage assembly further comprises a service assembly configured to display the overall weight of the case. Furthermore, the innovative smart luggage assembly may be cooperatively configured with a user platform to conveniently access information related to the weight of one or more smart luggage assemblies.

As mentioned above, the innovative smart luggage assembly may comprise a case with one or more independent segments. When two independent segments are provided, such may be pivotally movable with respect to one another and may be collectively disposed into and out of a closed position and an open position. Alternatively, a case may be provided comprising only one independent segment. Various mechanisms, e.g., zippers, may be provided to provide access to an inside of the case or an independent segment(s), or to otherwise provide a closing mechanism to the smart luggage assembly.

As also mentioned above, the smart luggage assembly comprises a detection assembly configured to ascertain information relating to the weight of one or more smart luggage assemblies. An independent segment may comprise a detection assembly disposed thereon, for example on or around a bottom portion of the case. The detection assembly may comprise a weight sensor, which may be for example a mechanical scale or an electronic weight sensor. Accordingly, the weight sensor may be configured to ascertain the weight associated with one or more segments of the case of a smart luggage assembly.

In embodiments of the smart luggage assembly comprising a built in mechanical scale, a downward vertical displacement of the weight sensor, with respect to the wheels and/or bottom portion of a case, are indicative of a specific weight associated with a particular travel configuration of the smart luggage assembly. For example, a substantially neutral position of the weight sensor(s) and the bottom portion of the case with respect to its wheels is indicative of only the weight of the case, without contents on an inside thereof. Conversely, a substantially lowered position of the weight sensor(s) and the bottom of the case with respect to its wheels is indicative of the well of the case as well as the weight of items or contents disposed on an inside thereof, which substantially occupy the entire capacity of the case. Other intermediate positions of the weight sensor(s) and the bottom portion of the case with respect to the position of the wheels, are indicative of the weight of the case and the weight of some items or contents disposed on an inside thereof, but which do not fully occupy the capacity of the case.

The service assembly of the innovative smart luggage assembly is generally configured to display information associated with the weight of an independent segment(s). The service assembly may comprise a display configured to show the overall weight of the case, including the weight of the items or contents disposed on an inside of the casing. The display may also be configured to show the overall weight of only one independent segment. Thus, an operative connection may be established between the detection assembly and the service assembly, for example between the weight sensor(s) and the display.

The service assembly may also comprise solar sensor. It is within the scope of the present invention that the smart luggage assembly comprise powering capabilities intended to provide electricity to the various operative components of the smart luggage assembly. Thus, the smart luggage assembly may comprise one or more rechargeable battery units. The solar sensor may be configured to capture solar energy and transform it into electricity that may be conveyed to a battery unit to replenish its charge, or alternatively such electricity may be transmitted directly to the operative components of the smart luggage assembly.

Further features of the present invention comprise implementing wireless capabilities to transmit weight data associated with one or more smart luggage assemblies. For example, weight data may be transmitted directly from the detection assembly to the display, from the detection assembly to a mobile or desktop device, or from the display to a mobile or desktop device. As will be explained below, the present invention also contemplates providing a user platform, which may be accessed via a variety of devices, mobile devices and/or desktop computers, to access weight data associated with one or more innovative smart luggage assemblies. A database accessible by the user platform may be continuously updated with data associated with the current and/or actual weight of one or more smart luggage assemblies.

Even further features of the present invention comprise incorporating real-time aviation information to the user platform. Such aviation information may be included in a real time database that may be accessed via the user platform. Accordingly, such aviation information may comprise commercial airline restrictions as to the number and weight of the luggage that may be checked in during a flight or that may be transported as a carry on item(s). Thus, the user platform may be accessed to compare whether the weight data associated with one or more given smart luggage assemblies comports to these travel requirements and/or guidelines from air carriers, or whether there should be made some adjustments to ensure conformance.

### BRIEF DESCRIPTION OF THE DRAWINGS

FIG. 1 is a perspective view of one embodiment of the smart luggage assembly disposed in a closed position.

FIG. 2 is a perspective view of another embodiment of the smart luggage assembly disposed in an open position.

FIG. 3 is a front view of a portion of one embodiment of an independent segment of the smart luggage assembly where the weight sensors are shown in a substantially neutral position.

FIG. 4 is a front view of a portion of another embodiment of an independent segment of the smart luggage assembly where the weight sensors are shown in a substantially lowered position.

FIG. 5 is a perspective view of one embodiment of the detection assembly according to the smart luggage assembly of the present invention.

FIG. 6 is a perspective view of another embodiment of the detection assembly according to the smart luggage assembly of the present invention.

FIG. 7 is a perspective view of one embodiment of a retainer of the detection assembly according to the smart luggage assembly of the present invention.

FIG. 8 is a perspective view of another embodiment of a retainer of the detection assembly according to the smart luggage assembly of the present invention.

FIG. 9 is a perspective view of yet another embodiment of a retainer of the detection assembly according to the smart luggage assembly of the present invention.

FIG. 10 is a perspective view of an even further embodiment of a retainer of the detection assembly according to the smart luggage assembly of the present invention.

FIG. 11 is a side cross-sectional view of one embodiment of the service assembly according to the smart luggage assembly of the present invention.

FIG. 12 is a diagrammatic representation of the method according to the present invention of using a user platform to verify the weight of a smart luggage unit(s).

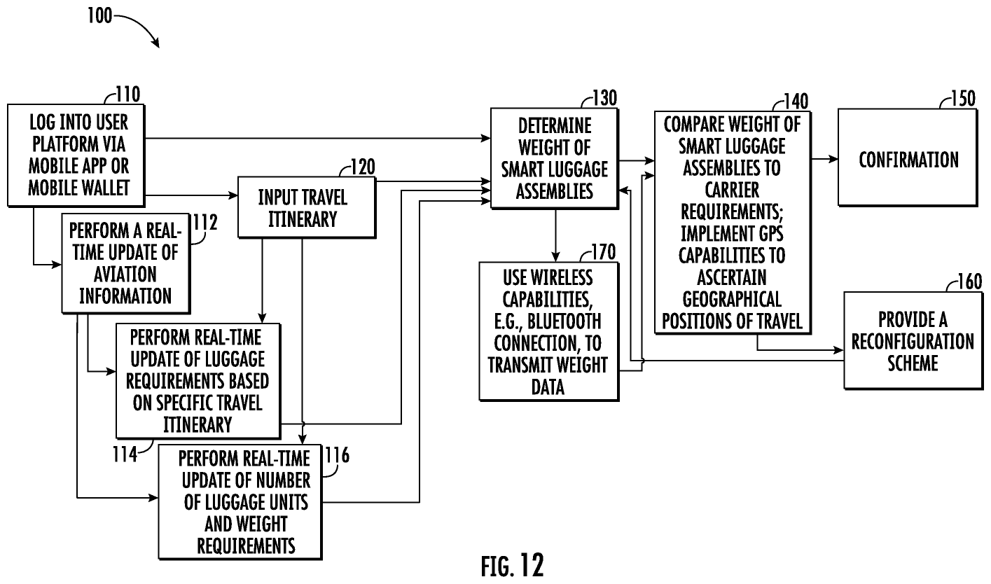

### DETAILED DESCRIPTION

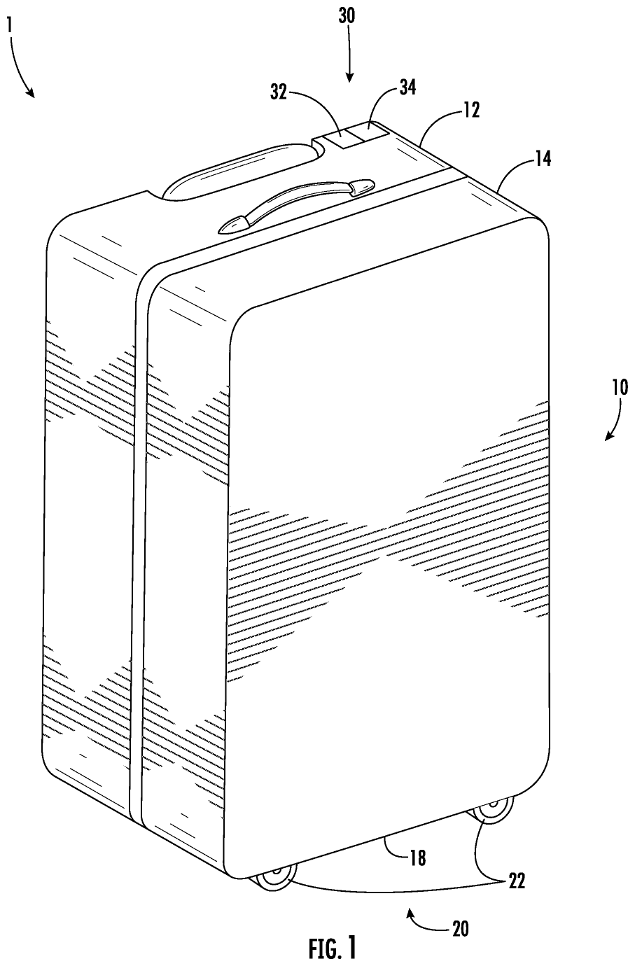

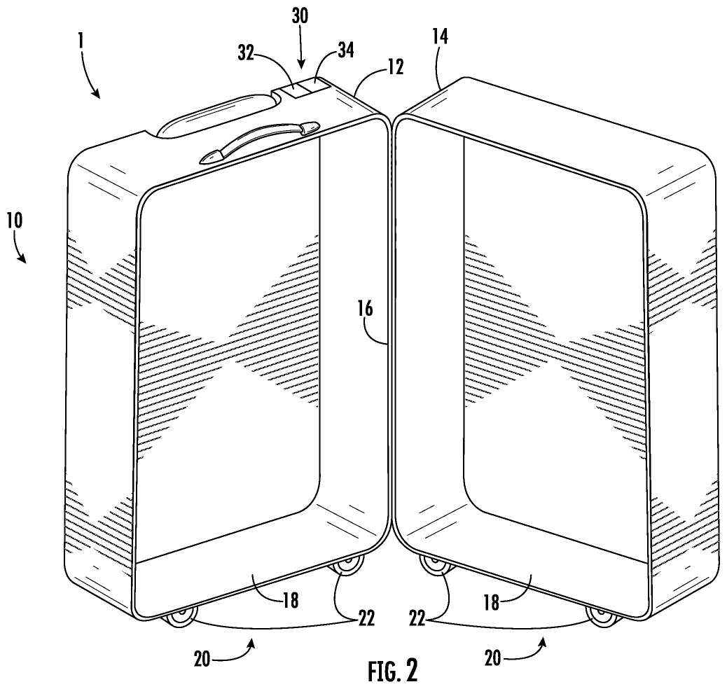

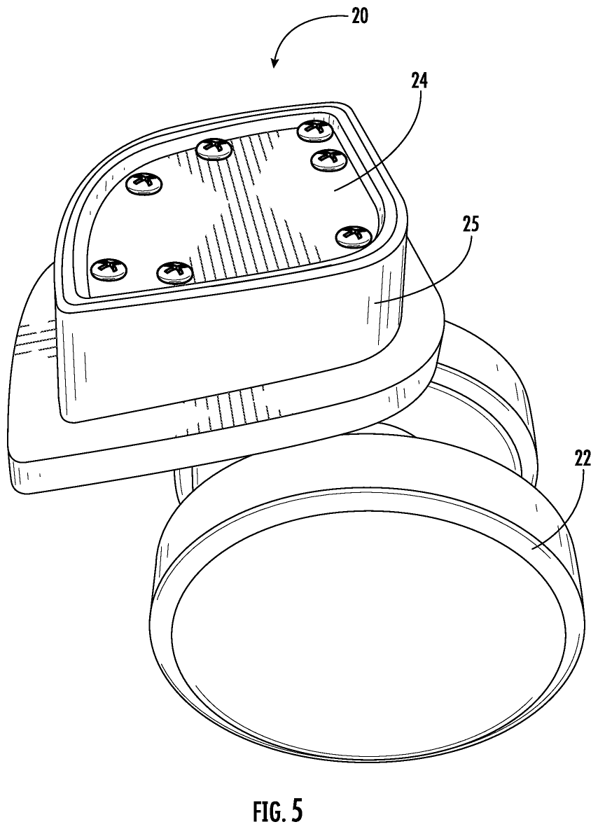

With initial reference to FIGS. 1-2, the present invention is directed towards a smart luggage assembly 1. With reference also to FIG. 5, the present invention is also directed towards a method 100 of using a user platform to ensure that the weight and number of smart unit assemblies 1 conforms to airline carrier requirements and guidelines. The smart luggage assembly 1 according to the present invention is intended to ascertain its own weight when it is empty, and when items are disposed on an inside thereof. The smart luggage assembly 1 comprises a case 10 having at least one independent segment, e.g. a first independent segment 12 and/or a second independent 14. As is perhaps best shown in FIG. 2, the smart luggage assembly 1 may comprise two independent segments, namely a first independent segment 12 and a second independent segment 14. The smart luggage assembly 1 further comprises a detection assembly 20. The detection assembly 20 is configured to ascertain the overall weight of the smart luggage assembly 1. The detection assembly 20 may be configured to ascertain the weight around the independent segment(s) 12 and/or 14 of the case 10. Additionally, the smart luggage assembly 1 comprises a service assembly 30 configured to display the overall weight of the case 10. As will be explained herein, one or more smart luggage assemblies 1 may be cooperatively configured with a user platform to conveniently access information associated weight information.

As mentioned above, and as shown at least in FIGS. 1-2, the smart luggage assembly 1 comprises a case 10 with at least one independent segment. It is within the scope of the present invention that the smart luggage assembly 1 may comprise a case 10 with two independent segments 12 and 14. The independent segments 12 and 14 may be connected along a longitudinal seam 16, which allows pivotal movement of the independent segments 12 and 14. For example, the seam 16 may allow for pivotal movement between the independent segments 12 and 14, between a closed position, as represented in FIG. 1, to an open position, as represented in FIG. 2. However, this is not strictly necessary, as other configurations are also possible. As a non-limiting example, the case 10 may include a single independent segment with a lid that may be opened with a zipper or other related mechanism.

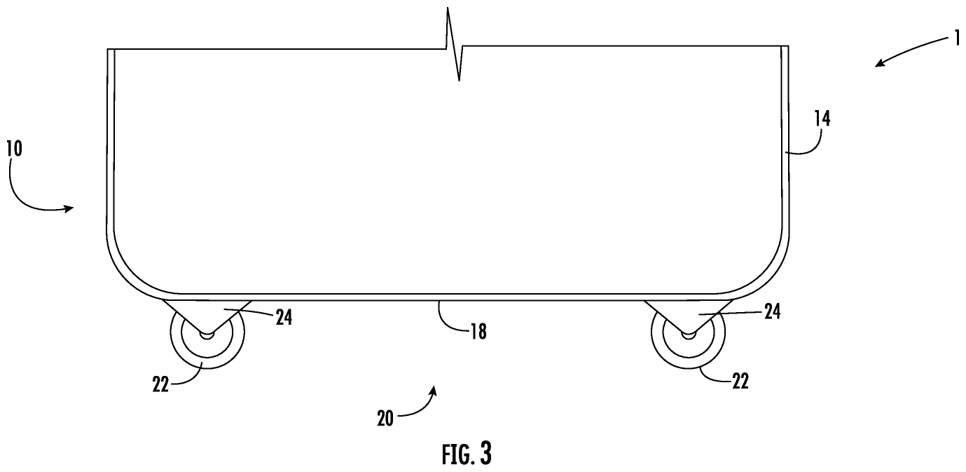

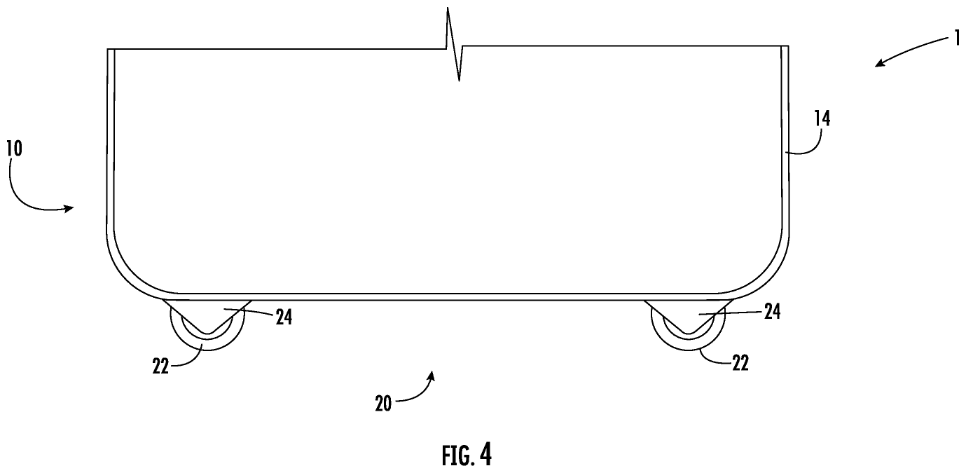

As also mentioned above and as is shown in FIGS. 1-2, the smart luggage assembly 1 comprises a detection assembly 20. With particular reference to FIG. 2, each segment, e.g., 12 and/or 14, of the case, may comprise a detection assembly 20 disposed thereon, for example in a bottom portion 18 of the first independent segment 12 and/or second independent segment 14. As is perhaps best shown in FIGS. 3-4, in at least one embodiment according to the present invention, the detection assembly 20 may comprise a weight sensor 24 disposed around a bottom portion 18. A weight sensor(s) 24 may be disposed around a corresponding wheel 22 of the smart luggage assembly 1. It is within the scope of the present invention that at least two wheels 22 be disposed on each independent segment, e.g., 12 and/or 14, so as to at least partially enable stability and/or facilitate movement of a smart luggage assembly 1. Thus, the weight sensor 24 may comprise a built-in mechanical scale and/or an electronic weight sensor, either of which may be configured to determine the composite weight of each independent segment 12 and/or 14. As used herein, the composite weight of an independent segment refers to the overall weight of the independent segment 12 and/or 14 with items or contents disposed on an inside thereof.

With reference to FIGS. 3-4, in at least one illustrative embodiment of the present invention, the weight sensor 24 may comprise a built-in mechanical scale disposed around the wheels 22 of the smart luggage assembly 1. In such embodiments, it is within the scope of the present invention that a downward displacement of the vertical position of at least the bottom portion 18 of the case 10 be indicative of the overall weight associated with an independent segment 12 and/or 14. For example, the illustrative embodiment as represented in FIG. 3 shows a substantially neutral position of the weight sensors 24, and the bottom portion 18, with respect to the vertical position of the wheels 22. Thus, in the illustrative embodiment represented in FIG. 3, such a substantially neutral position of the weight sensor 24 and the bottom portion 18 is substantially indicative of only the weight of only the case 10, i.e., without items on an inside thereof. Conversely, the illustrative embodiment as represented in FIG. 4 shows a substantially lowered position of the weight sensors 24, and the bottom portion 18, with respect to the vertical position of the wheels 22. In the illustrative embodiment represented in FIG. 4, such a substantially lowered position of the weight sensors 24 and the bottom portion 18 is substantially indicative of the composite weight of the case 10, i.e., the weight of the case 10 as well as the weight of items or contents disposed on an inside thereof, which substantially occupy the entire capacity of both independent segments 12 and 14 of the case 10. It is also possible to achieve intermediate vertical positions of the weight sensor 24, which are indicative of the weight of an independent segment 12 and/or 14 with some items or contents disposed thereon, but which occupy some capacity of the independent segments 12 and/or 14, but not their full capacity.

The electronic weight sensor(s) 24 may comprise a variety of sensor technologies. As an illustrative example, the weight sensor(s) 24 may comprise a load cell, e.g., a force transducer, which is configured to convert compression or pressure into an electrical signal that may be measured and/or standardized. For example, as a force applied to the load cell increases, the electrical signal may change proportionally. Thereafter the electrical signal(s) may be processed and/or converted into a corresponding weight value. As a further example, a force sensing resistor (FSR) may be incorporated. A force sensing resistor (FSR) may comprise a material configured to change its resistance when a force, pressure, or mechanical stress is applied. The change in resistance may be converted into an electrical signal, e.g., via the processing unit 40. The size and/or shape of the electronic weight sensor(s) 24 may be dimensioned and configured according to the specific size of the wheels 22 and/or case 10.

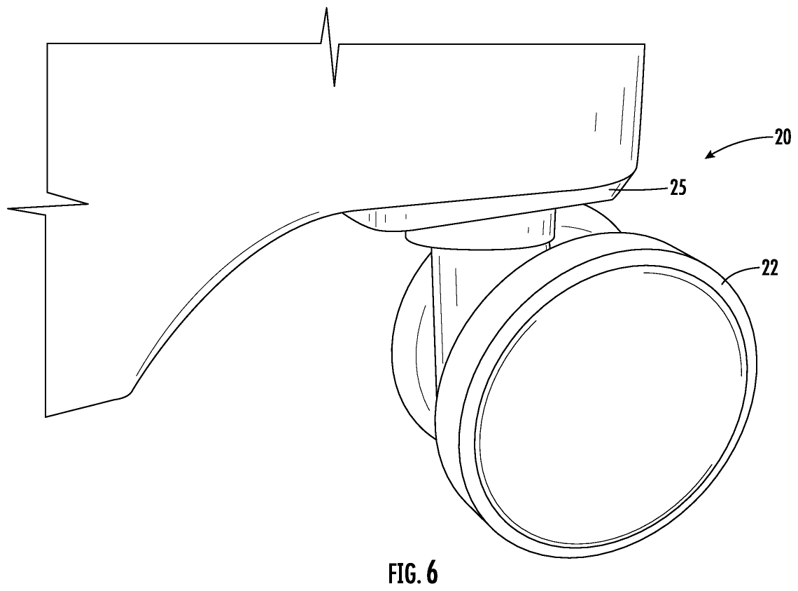

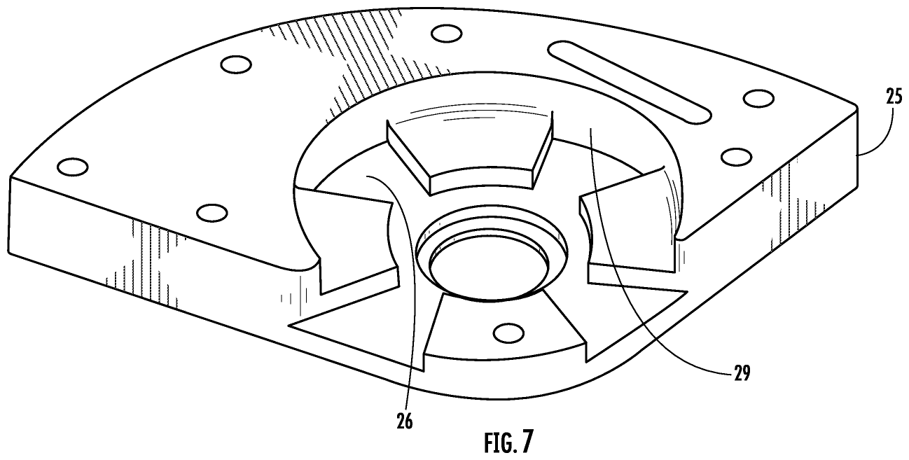

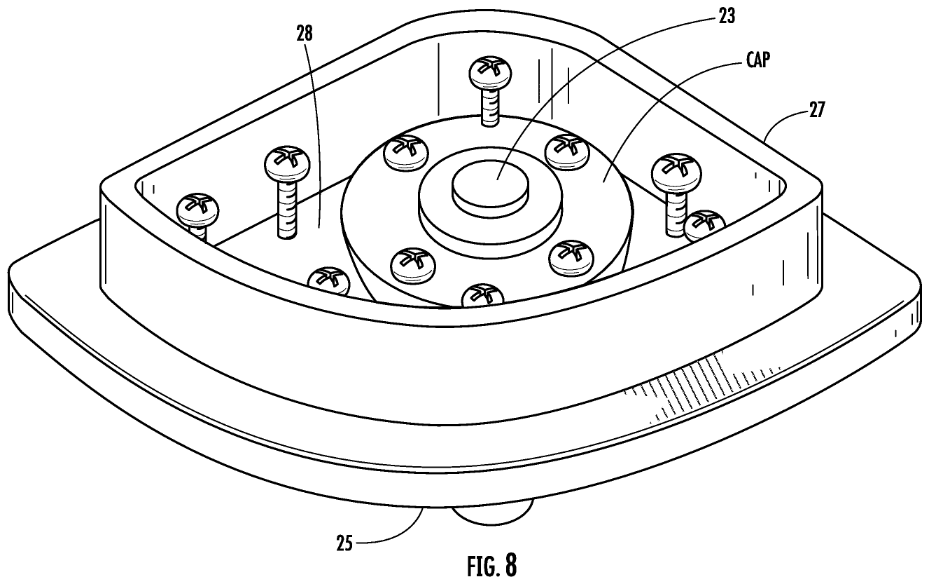

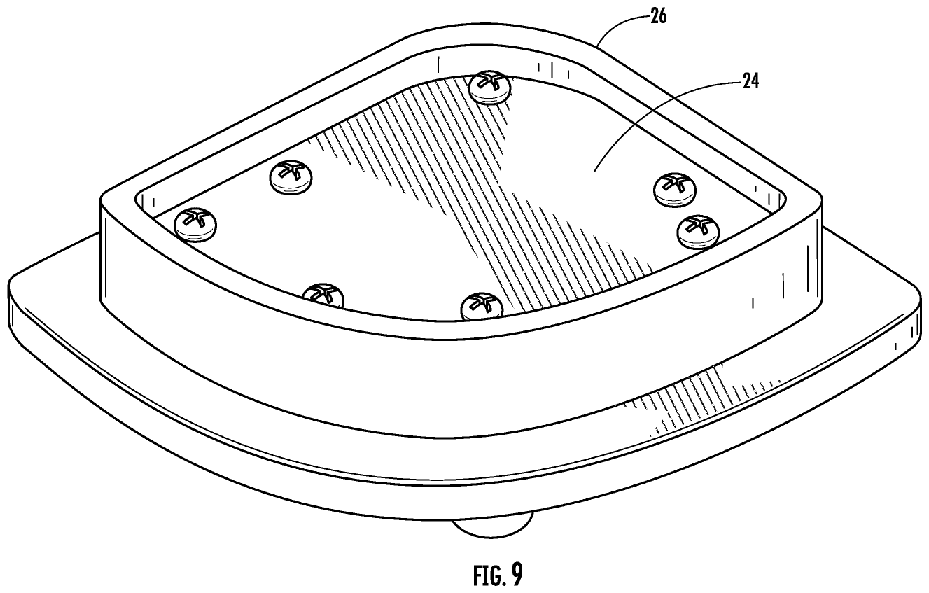

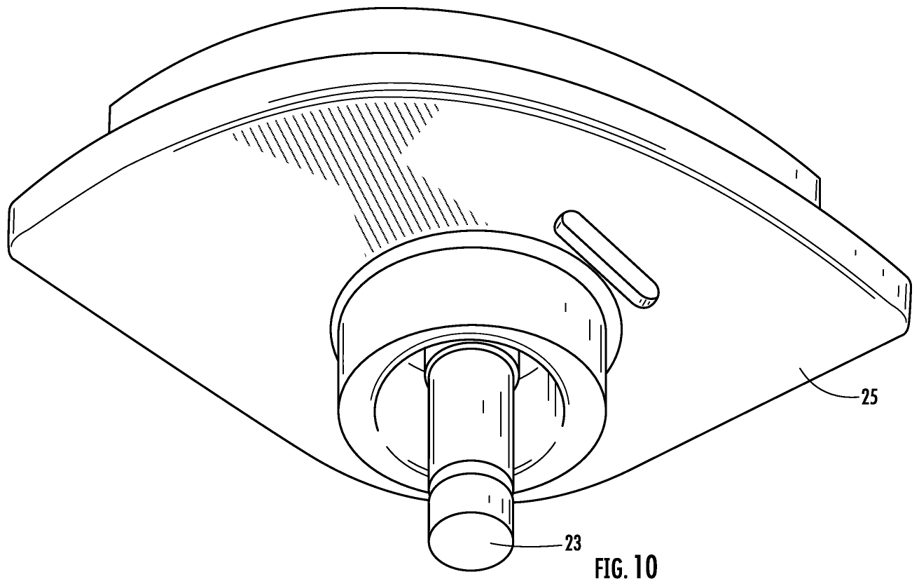

With reference to the illustrative embodiments of FIGS. 5-10, the smart luggage assembly 10 may comprise a plurality of retainers 25. Each retainer 25 is intended to interconnect a corresponding wheel 22 to at least a portion of the case 10. Furthermore, each retainer is also intended to retain and/or house a corresponding weight sensor 24. As shown in FIG. 7, each retainer 25 may comprise a socket 26 where various components of a corresponding wheel 22 may be disposed. For example, as shown in FIG. 8, a cap and/or a wheel connecting portion 23 and/or attendant components may be disposed on the socket 26 and/or an aperture disposed around the socket 26. As is also shown in FIG. 8, each retainer 25 may comprise a sidewall 27 configured and dimensioned to substantially define an enclosure 28. It is within the scope of the present invention that the height of the sidewall be sufficient to accommodate not only the wheel connecting portion 23 and/or its attendant components, i.e., cap, screws, etc., but also the weight sensor 24. For example, as shown in the illustrative embodiment of FIG. 9, a weight sensor 24 may be disposed on the enclosure 28, and the weight sensor itself may be at least partially surrounded by the sidewall 27. As shown in FIG. 10, a wheel connecting portion 23 may extend and protrude or otherwise project to an opposite side of the retainer 25. The wheel connecting portion 23 may be used to connect to the wheel 22 itself.

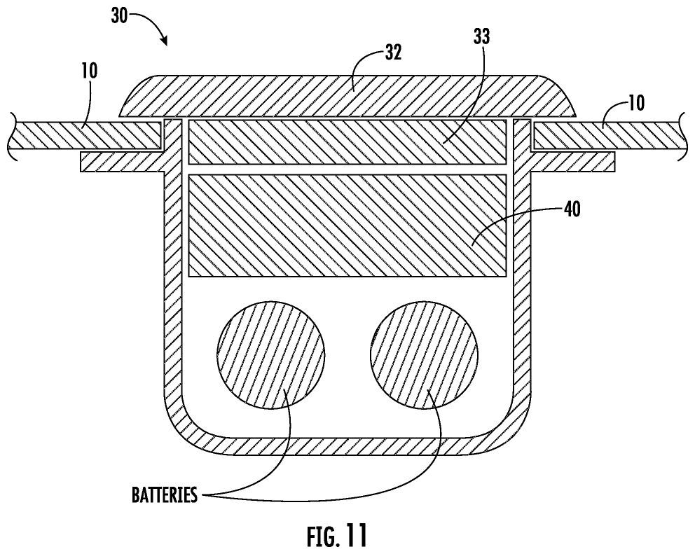

As is shown in the illustrative embodiments of at least FIG. 11, the present invention comprises a processing unit 40. The processing unit 40 and/or processing board 40 may comprise a microprocessor, which may be cooperatively configured with the weight sensor(s) 24, of the detection assembly 20 to convert a pressure, force, stress, or change thereof, into an electrical signal representative of an associated weight. Furthermore, the processing unit 40 may also be operatively configured with the service assembly 30, e.g. with a display 32, to show such weight as may be associated with the pressure, force, stress and/or change thereof. It is within the scope of the present invention that the processing unit 40 and/or components thereof comprise at least a minimum level of flexibility that allows for an integration into the pad 10 and/or sensor(s) 24. It is also within the scope of the present invention that the processing unit 40 be configured with a programmable code or executable computer software for the purposes of integrating the sensor(s) 24 and/or service assembly 30. The processing unit 40 may comprise an open-source hardware and/or software package that includes single-board microcontrollers and microcontroller kits. By way of example only, the processing unit 40 may comprise a processing board manufactured by Arduino, LLC, and/or under the brand Arduino®.

As may be appreciated from FIGS. 1-2 and 11, the present invention contemplates providing a service assembly 30. The service assembly 30 is primarily intended to serve as a mechanism to show information associated with the weight of an independent segment 12 and/or 14. As such, the service assembly 30 may comprise a display 32. For example, the service assembly may comprise an outer display 32 operatively configured with a display glass 33. The display 32 may be configured to show the overall weight of the case 10, including with items or contents disposed on an inside of the independent segments 12 and/or 14. Alternatively, the display 32 may also be configured to show the overall weight of only one of the independent segments 12 or 14. Such display configuration of only one of the independent segments 12 or 14 may be advantageous in order to assist in evenly distributing the weight of the items or contents on an inside of an independent segment 12 and/or 14. Thus, it is within the scope of the present invention that an operative connection be established between the detection assembly 20 and the service assembly 30. For example, an operative connection may be established between the weight sensor(s) 24 and the display 32 of the service assembly 30. Such operative connection may be enabled via wired configurations or wirelessly via a variety of technologies, including, Bluetooth®, Wi-Fi, LAN, Near-Field Communication (NFC) capabilities, and other related tools. Such operative connection may also be at least partially enabled via software or executable code, and by implementing a variety of hardware components including emitters, transmitters, routers, wires, cabling, etc. Such hardware components may be disposed in proximity respectively to the weight sensor(s) 24 and/or the display 32 of the service assembly 30.

With reference again to FIGS. 1-2, the service assembly 30 may also comprise solar sensor, which is indicated as 34. It is within the scope of the present invention that the smart luggage assembly 1 comprise powering capabilities. Such powering capabilities are intended to provide the necessary electricity for the functioning of the various operative components, including, the weight sensor(s) 24, the display 32, and/or the attendant components that enable an operative communication between them. Thus, the smart luggage assembly 1 may comprise one or more battery units, e.g., as shown in FIG. 11. The battery unit(s) may comprise rechargeable batteries and/or may be disposed on an inside of the case 10. Alternatively, and as is shown in FIGS. 1-2, the service assembly 30 may comprise a solar sensor 34. The solar sensor 34 may comprise a photovoltaic cell panel configured to capture solar energy and transform it into electricity. In at least one embodiment, the solar sensor 34 is configured to transform solar energy into electricity that will replenish the charge of a battery unit(s). In at least another embodiment, the electricity generated by the solar sensor 34 will be transmitted directly to the operative components of the smart luggage assembly 1, e.g., weight sensor(s) 24, the display 32, attendant components, etc. accordingly, the solar sensor 34 may be operatively connected with the processing unit 40 to provide electricity to the operative components of the smart luggage assembly 1.

Further features of the present invention comprise implementing wireless capabilities to transmit weight data associated with one or more smart luggage assemblies 1. Wireless capabilities, including, but not limited to, Bluetooth®, Wi-Fi, LAN, Near-Field Communication (NFC) capabilities, may be used to transmit data associated with the weight of one or more innovative smart luggage assemblies 1. For example, weight data may be transmitted directly from the detection assembly 20, i.e., via the weight sensor(s) 24, to the service assembly 30, i.e., to the display 32. The present invention also contemplates providing a user platform, as will be explained later, which may be accessed via a variety of devices, including mobile devices, in the form of a mobile application, and/or desktop computers via a web browser. As such, weight data may be transmitted wirelessly from the detection assembly 20 to the mobile or desktop device, for example via a server, data network, cloud computing, etc. The weight data may be similarly transmitted wirelessly from the service assembly 30 to a mobile or desktop device.

As mentioned above, further features of the present invention comprise providing a user platform. The user platform may be accessed by one or more users to access weight data associated with one or more innovative smart luggage assemblies 1. It is within the scope of the present invention that the user platform be continuously updated in “real-time”, which generally may involve updating with up-to-date or recent information regarding the current and/or actual weight of a given smart luggage assembly 1. It is contemplated that such current and/or actual weight of a given smart luggage assembly 1 be ascertained and/or displayed with the components of the smart luggage assembly 1, e.g., sensors 24, processing unit 40, display 32, etc. The user platform may also be provided with global positioning system (GPS) tracking capabilities, as may be required in connection with planning and/or implementing a travel itinerary. Such GPS tracking capabilities may comprise internal hardware components disposed on a smart luggage assembly 1, for example, a receiver configured to obtain radio signals and ascertain a current location of one or more smart luggage assemblies 1. Such GPS tracking capabilities may also be used to ascertain a location of one or more smart luggage assemblies 1 if, for example, they are misplaced, lost, sent to an incorrect location, etc. Further, such GPS tracking capabilities may be configured to ascertain data relating to a specific location(s) of one or more smart luggage assemblies 1, including various positions of travel in connection with a travel itinerary. Such GPS data may be displayed on the user platform such that the owner of the smart luggage assembly 1 may determine its location at any given point.

Therefore, the user platform may be accessed by one or more users via an application installed on a mobile device to allow users to check real-time data associated with the weight of one or more smart luggage assemblies 1. Alternatively, and in addition to or in lieu of a standalone mobile application installed on a device, various features of the user platform may be conveniently accessed and/or stored on a device via a mobile wallet or through a web server(s) accessible via a mobile device.

Even further features of the present invention comprise incorporating real-time aviation information to the user platform. Such aviation information may be included in a real time database that may be accessed via the user platform. Accordingly, such aviation information may comprise commercial airline luggage restrictions, for example, number of allowed luggage units allowed on a given national or international flight, and its weight restrictions for on-board luggage and/or carry-on luggage. Such restrictions in the number and weight of luggage may vary according to each specific commercial airline and/or the nature of the underlying flight, for example whether it is within a state, within a country, between more than one country, and/or the estimated travel time. Accordingly, the user platform may be accessed to compare whether the weight data associated with one or more given smart luggage assemblies 1 comports to these travel requirements and/or guidelines from air carriers. If the smart luggage assemblies 1 do not comport to specific travel requirements or guidelines, the user platform may indicate which smart luggage assemblies 1 may need weight adjustments, and how much such adjustments may need to be. The user platform may also provide information associated with additional carrier fees associated with the current weight configuration of one or more smart luggage assemblies 1. Accordingly, it is within the scope of the present invention that the user platform be accessed to input specific travel information, e.g., airline, flight number, destination, city of origin, current flight, future flights, number of passengers, etc., and link this information with one or more smart luggage assemblies 1. As such, the user platform may provide for an efficient way to confirm that one or more travel configurations, that is one or more smart luggage assemblies 1 and their associated weight data, comport to the specific requirements associated with a specific travel itinerary. The user platform is also intended to be an easy to access resource to implement a weight reconfiguration scheme, i.e., to make weight adjustments to one or more smart luggage assemblies 1, as may become necessary to comport to such requirements and/or limit additional carrier fees associated with a specific travel itinerary.

With reference now to FIG. 5, and as mentioned above, the present invention is also directed towards a method 100 of ensuring that the weight and number of smart unit assemblies 1 associated with a given travel itinerary conform to specific requirements and guidelines of air carriers. Furthermore, embodiments of the method 100 further comprise incorporating the inventive smart luggage assembly 1 conformance to requirements and guidelines of air carriers. Accordingly, the method 100 comprises logging into a user platform as described herein. This may be accomplished via a mobile or desktop device, for example via a mobile application, web browser, or via a mobile wallet. The method 100 further comprises preforming a real-time update of aviation information 112 to the user platform. That is, a database accessibly by, or otherwise associated with, the user platform, may be updated with specific requirements and/or guidelines of air carriers, for example, commercial airlines, airport regulations, etc. The method 100 may comprise a user inputting a flight itinerary 120, and performing a real-time update of specific requirements and/or guidelines based on the specific travel or flight itinerary 114. As used herein, inputting a flight itinerary 120 may comprise synching, creating, or otherwise enabling a flight itinerary or travel ticket to be accessible via the user platform, and/or also by airport staff, e.g., airline staff, TSA, security, etc. Furthermore, the method may comprise performing a real-time update of the number and weight of permissible luggage units of a specific travel itinerary 116. The method 100 further comprises determining the weight of at least one smart luggage assembly 130. For example, the method 100 may comprise providing and using the smart luggage assembly 1 to determine the weight of at least one luggage unit 130.

Wireless capabilities, for example Bluetooth connectivity, may be used to transmit data relating to the weight of one or more smart luggage assemblies 170. For example, data relating to the weight or one or more smart luggage assemblies 170 may be transmitted from the electronic weight sensor assembly 1 to the user platform. Data relating to the weight of one or more smart luggage assemblies may also be transmitted, for example, to a server, data network, cloud computing, etc., of the air carrier. For example, data relating to the weight of a luggage unit(s) may be associated with a travel itinerary or an actual ticket, e.g., a ticket that may be printed or that be accessed through a mobile app, mobile wallet, web browser, etc. The method 100 further comprises comparing the weight data of the smart luggage assemblies to air carrier requirements and guidelines 140. For example, it is within the scope of the present invention that the air carrier staff and/or airport staff, have immediate access to the data relating to the weight of a one or more smart luggage assemblies 1, for example, prior to arrival at the airport. This may at least partially reduce the amount of time associated with baggage check-in, and may also reduce the time and effort the staff will have otherwise needed to weight one or more smart luggage assemblies 1 upon arrival at the airport. This may also at least partially reduce the staff's physical contact with the smart luggage assembly 1 or assemblies 1 and may be used to expedite luggage check-in procedures, for example, via first class travel, pre-approved check-in, TSA, etc. For example, an curbside check-in kiosk, or an inside check-in kiosk, may have access to the weight of a unit(s) of luggage the moment a user uses the electronic weight sensor assembly 1 to ascertain the weight thereof. As an example, the user may access the user platform to record or otherwise save a weight reading of the smart unit assembly 1 of a unit of luggage(s), and that information may linked or associated with a ticket or travel itinerary in real-time.

In addition, as shown at 140, GPS capabilities may also be implemented to determine a geographical position in connection with a travel itinerary. If the actual weight and number of the smart luggage assemblies is in conformance to the air carrier requirements and guidelines, the method 100 comprises providing a confirmation 150. If the actual weight and number of the smart luggage assemblies is not in conformance to the air carrier requirements and guidelines, the method 100 may comprise implementing or providing a reconfiguration scheme 160. It is contemplated that with a reconfiguration scheme, that the user adjust the weight and/or number of the smart luggage assemblies 1 such that their weight may be determined again to verify and/or ensure conformance to the air carrier requirements and guidelines. For example, the reconfiguration scheme 160 may comprise an alarm sent to the user via the user platform, i.e., on a mobile application or a mobile wallet, and it may also indicate which smart luggage assembly 1 may not conform to the specific travel requirements and/or guidelines. This process may be repeated until the weight and/or number of the smart luggage assemblies are in conformance with the air carrier requirements.

Further features of the method 100 according to the present invention comprise providing an alert upon the occurrence of a predetermined condition. Such an alert may be sent, for example, when the weight of a smart luggage assembly 1 increases beyond conformance with the carrier requirements for each specific travel itinerary. In such cases, a reconfiguration scheme 160 may be implemented and a new reading of actual weight may be ascertained to ensure conformance to the requirements. Additionally, an alert may also be sent if there are any changes in the weight of the smart luggage assembly 1 beyond a predetermined threshold, e.g., 3 lbs or 5 lbs. An alert may also be sent if the smart luggage assembly 1 is misplaced or lost, or if is located beyond a predetermined radius from the location of the user, e.g., as indicated by the location of the user's mobile phone accessing the using platform via a mobile application.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A smart luggage assembly configured to ascertain its own weight, said electronic luggage assembly comprising:
a case comprising at least one independent segment,
a plurality of wheels, each one of a plurality of wheels operatively disposed on said case,
a detection assembly comprising a plurality of weight sensors, each one of said plurality of weight sensors adjacently disposed to a corresponding one of said plurality of wheels,
a processing unit operatively disposed on said case, and
each one of said plurality of weight sensors operatively configured with said processing unit to ascertain at least a portion of the weight of said electronic luggage assembly.

2. The smart luggage assembly as recited in claim 1 further comprising a first independent segment and a second independent segment connected to and movable to one another.

3. The smart luggage assembly as recited in claim 2 wherein at least one of said plurality of wheels is operatively disposed on a bottom portion of said first independent segment.

4. The smart luggage assembly as recited in claim 3 wherein two of said plurality of wheels are operatively disposed on a bottom portion of said first independent segment.

5. The smart luggage assembly as recited in claim 2 wherein at least one of said plurality of wheels is operatively disposed on a bottom portion of said second independent segment.

6. The smart luggage assembly as recited in claim 5 wherein two of said plurality of wheels are operatively disposed on a bottom portion of said second independent segment.

7. The smart luggage assembly as recited in claim 1 further comprising a service assembly operatively disposed with said processing unit.

8. The smart luggage assembly as recited in claim 7 wherein said service assembly comprises a display cooperatively configured with said processing unit to show an actual weight reading of said smart luggage assembly.

9. The smart luggage assembly as recited in claim 7 wherein said service assembly comprises a solar sensor operatively connected with said processing unit and configured to generate electricity at least for said plurality of weight sensors.

10. The smart luggage assembly as recited in claim 9 wherein said service assembly comprises a display; said solar sensor configured to generate electricity for said display.

11. The smart luggage assembly as recited in claim 1 further comprising a plurality of retainers each one disposed on said case.

12. The smart luggage assembly as recited in claim 11 wherein each one of said plurality of retainers is dimensioned and configured to house a corresponding one of said plurality of weight sensors.

13. The smart luggage assembly as recited in claim 12 wherein each one of said plurality of retainers comprises a sidewall configured and dimensioned to substantially define an enclosure; said enclosure configured and dimensioned to house a corresponding one of said plurality of weight sensors

14. The smart luggage assembly as recited in claim 11 wherein each one of said plurality of retainers is configured to interconnect a corresponding one of said plurality of wheels to said case.

15. The smart luggage assembly as recited in claim 14 wherein each one of said plurality of retainers comprises a socket structured to retain a connecting portion of a corresponding one of said plurality of wheels.

16. The smart luggage assembly as recited in claim 1 wherein each one of said plurality of weight sensors comprises a force sensing resistor (FSR) operatively configured with said processing unit and structured to ascertain at least a portion of the weight of said electronic luggage assembly.

17. A smart luggage assembly configured to ascertain its own weight, said electronic luggage assembly comprising:
a case comprising a first independent segment and a second independent segment, said first independent segment connected to and movable to said second independent segment,
two wheels disposed on a bottom portion of said first independent segment,
two wheels disposed on a bottom portion of said second independent segment,
a detection assembly comprising four weight sensors, each one of four weight sensors adjacently disposed to a corresponding one of said four wheels,
each one of said plurality of sensors operatively configured with said processor to ascertain at least a portion of the weight of said electronic luggage assembly,
a processing unit operatively disposed on said case,
a service assembly comprising a display operatively connected to said processing unit and at least partially disposed and viewable around a top portion of said case, and
said processing unit adjacently disposed to said display.

18. A method of using a smart luggage assembly for ascertaining and displaying its own weight, the method comprising:
providing an electronic luggage assembly comprising:
a case comprising at least one independent segment,
a plurality of wheels, each one of a plurality of wheels operatively disposed on the case,
a detection assembly comprising a plurality of weight sensors, each one of the plurality of weight sensors adjacently disposed to a corresponding one of the plurality of wheels,
a processing unit operatively disposed on the case, and
each one of the plurality of weight sensors operatively configured with the processing unit to ascertain at least a portion of the weight of the electronic luggage assembly,
logging into a user platform,
performing a real-time update of aviation information,
inputting a travel itinerary,
using the electronic luggage assembly to ascertain its own weight, and
comparing the weight the electronic unit of luggage to air carrier requirements, and providing a confirmation to the user if the weight of electronic unit of luggage conforms to the air carrier requirements.

19. The method as recited in claim 18 further comprising providing a reconfiguration scheme if the weight of the smart luggage assembly does not conform to the air carrier requirements.

20. The method as recited in claim 18 further comprising performing a real-time update of luggage requirements based on a specific travel itinerary.
